(19) United States
(12) Patent Application Publication
(10) Pub. No.: US 2010/0231735 A1
(43) Pub. Date: Sep. 16, 2010

(54) Methods, Apparatuses, and Computer Program Products for Facilitating Concurrent Video Recording and Still Image Capture

(75) Inventors: Adrian Burian, Tampere (FI); Maija Katariina Rajala, Tampere (FI); Janne Iisakki Lahteenmaki, Tampere (FI); Muhammad Asif Raza Azhar, Tampere (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 12/403,434

(22) Filed: Mar. 13, 2009

(51) Int. Cl. H04N 5/225; H04N 5/91

(52) U.S. Cl. 348/220.1; 386/83; 348/E05.024

(57) ABSTRACT

A method, apparatus, and computer program product are provided for facilitating concurrent video recording and still image capture. A method may include receiving a first command to initiate a video recording session. The first command may be responsive to a first user actuation of a trigger on a multi-function mobile computing device. The method may further include initiating the video recording session in response to receipt of the first command. The method may additionally include receiving a second command to capture a still image. The second command may be responsive to a second user actuation of the trigger. The method may also include initiating capture of the still image concurrent with the video recording session in response to receipt of the second command. Corresponding computer program products and apparatuses are also provided.

### TECHNOLOGICAL FIELD

Embodiments of the present invention relate generally to communication technology and, more particularly, relate to methods, apparatuses, and computer program products for facilitating concurrent video recording and still image capture.

### BACKGROUND

The modern computing era has brought about a tremendous expansion in the capabilities, prevalence, and convenience of mobile computing devices. These mobile computing devices, such as cellular phones, personal digital assistants (PDAs), and other portable electronic devices have evolved from luxury items to ubiquitous devices integrated into the everyday lives of individuals from all walks of life. Mobile computing devices now include much of the functionality of larger desktop and laptop computing devices and many mobile computing devices combine the functionalities of multiple electronic devices into a single integrated device.

For example, some of these multi-function mobile computing devices integrate at least some of the functionality of a video camera and a still image camera into a single mobile computing device. Such a multi-function mobile computing device may additionally provide for cellular phone functionality, mobile web browsing, mobile email service, global positioning system services, and/or other computing functions. However, the functionality integrated into a multi-function mobile device may be somewhat less than the functionality included on dedicated or larger computing devices, such as due to hardware limitations compared to dedicated or larger computing devices. Further, as the user interface of a multi-function mobile computing device may be somewhat limited or at least more generalized compared to dedicated computing devices, the user experience may be somewhat negatively impacted when using a multi-function mobile computing device.

One example wherein a multi-function mobile computing device may not provide the full functionality of special-purpose dedicated computing devices is concurrent video recording and still image capture. In this regard, dedicated video camera devices may include specifically tailored hardware and user interfaces to facilitate concurrent video recording and still image capture. However, multi-function mobile computing devices may not include sufficient user input means, such as buttons or switches, to allow for dedicated assignment of input means for both still image and video capture functions to enable a user to concurrently record a video and capture a still image. Further, hardware limitations in a multi-function mobile computing device may limit the ability or even prevent concurrent video recording and still image capture, such as due to the processing power and memory resources necessary for concurrent video recording and still image capture.

Accordingly, it may be advantageous to provide methods, apparatuses, and computer program products for facilitating concurrent video recording and still image capture.

### BRIEF SUMMARY OF SOME EXAMPLES OF THE INVENTION

A method, apparatus, and computer program product are therefore provided for facilitating concurrent video recording and still image capture. In this regard, a method, apparatus, and computer program product are provided that may provide several advantages to computing devices and computing device users. Embodiments of the invention provide for a method, apparatus, and computer program product to facilitate concurrent video recording and still image capture in multi-function mobile computing devices. In this regard, embodiments of the invention provide for concurrent video recording and still image capture using a single trigger on a multi-function mobile computing device. Embodiments of the invention further provide for automatic determination by a camera driver of configuration settings to use for still image capture so as not to disrupt an ongoing video recording session.

In a first exemplary embodiment, a method is provided, which includes receiving a first command to initiate a video recording session. The first command of this embodiment is responsive to a first user actuation of a trigger. The trigger of this embodiment may be embodied on a multi-function mobile computing device. The method of this embodiment further comprises initiating the video recording session in response to receipt of the first command. The method of this embodiment additionally comprises receiving a second command to capture a still image. The second command of this embodiment is responsive to a second user actuation of the trigger. The method of this embodiment also comprises initiating capture of the still image concurrent with the video recording session in response to receipt of the second command.

In another exemplary embodiment, a computer program product is provided. The computer program product includes at least one computer-readable storage medium having computer-readable program instructions stored therein. The computer-readable program instructions may include a plurality of program instructions. Although in this summary, the program instructions are ordered, it will be appreciated that this summary is provided merely for purposes of example and the ordering is merely to facilitate summarizing the computer program product. The example ordering in no way limits the implementation of the associated computer program instructions. The first program instruction of this embodiment is configured for causing a first command to initiate a video recording session to be received. The first command of this embodiment is responsive to a first user actuation of a trigger. The trigger of this embodiment may be embodied on a multi-function mobile computing device. The second program instruction of this embodiment is configured for providing for initiation of the video recording session in response to receipt of the first command. The third program instruction of this embodiment is configured for causing a second command to capture a still image to be received. The second command of this embodiment is responsive to a second user actuation of the trigger. The fourth program instruction of this embodiment is configured for providing for initiation of capture of the still image concurrent with the video recording session in response to receipt of the second command.

In another exemplary embodiment, an apparatus is provided. The apparatus of this embodiment includes a processor and a memory that stores instructions that when executed by the processor cause the apparatus to receive a first command to initiate a video recording session. The first command of this embodiment is responsive to a first user actuation of a trigger of the apparatus. The instructions of this embodiment when executed by the processor further cause the apparatus to initiate the video recording session in response to receipt of the first command. The instructions of this embodiment when executed by the processor additionally cause the apparatus to receive a second command to capture a still image. The second command of this embodiment is responsive to a second user actuation of the trigger. The instructions of this embodiment when executed by the processor also cause the apparatus to initiate capture of the still image concurrent with the video recording session in response to receipt of the second command.

In another exemplary embodiment, an apparatus is provided, which includes means for receiving a first command to initiate a video recording session. The first command of this embodiment is responsive to a first user actuation of a trigger. The trigger of this embodiment may be embodied on a multi-function mobile computing device. The apparatus of this embodiment further comprises means for initiating the video recording session in response to receipt of the first command. The apparatus of this embodiment additionally comprises receiving a second command to capture a still image. The second command of this embodiment is responsive to a second user actuation of the trigger. The apparatus of this embodiment also comprises means for initiating capture of the still image concurrent with the video recording session in response to receipt of the second command.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those here summarized.

### BRIEF DESCRIPTION OF THE DRAWING(S)

Having thus described embodiments of the invention in general terms, reference will now be made to the accompanying drawings, which are not necessarily drawn to scale, and wherein:

FIG. 1 illustrates a multi-function mobile computing device for facilitating concurrent video recording and still image capture according to an exemplary embodiment of the present invention;

FIG. 2 illustrates screen captures of a graphic user interface for facilitating concurrent video recording and still image capture according to an exemplary embodiment of the present invention; and

FIG. 3 illustrates a flowchart according to an exemplary method for facilitating concurrent video recording and still image capture according to an exemplary embodiment of the present invention.

### DETAILED DESCRIPTION

Some embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

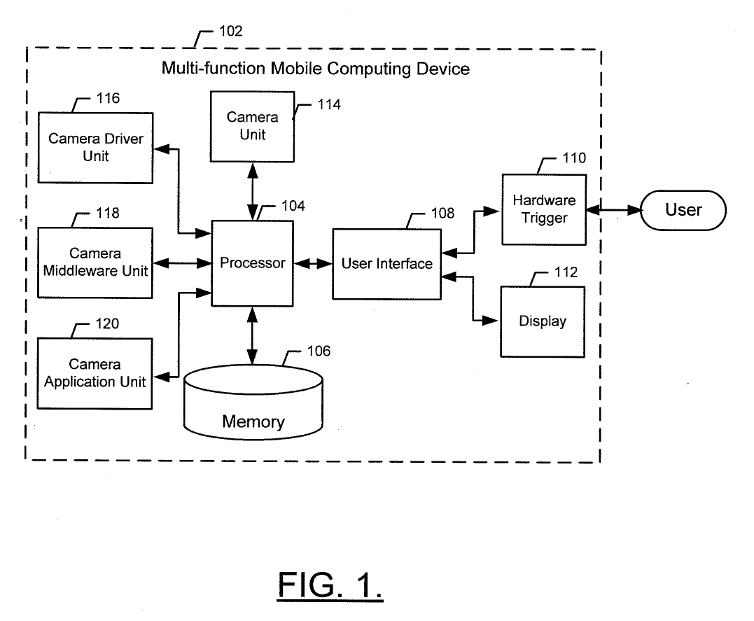

FIG. 1 illustrates a block diagram of a multi-function mobile computing device 102 for facilitating concurrent video recording and still image capture according to an exemplary embodiment of the present invention. As used herein, “exemplary” merely means an example and as such represents one example embodiment for the invention and should not be construed to narrow the scope or spirit of the invention in any way. It will be appreciated that the scope of the invention encompasses many potential embodiments in addition to those illustrated and described herein. As such, while FIG. 1 illustrates one example of a configuration of a multi-function mobile computing device for facilitating concurrent video recording and still image capture, numerous other configurations may also be used to implement embodiments of the present invention.

The multi-function mobile computing device 102 comprises a portable apparatus providing a plurality of functions including digital video recording and still image capture. The multi-function mobile computing device 102 may provide one or more functions in addition to digital video recording and still image captures, such as, for example, cellular communications (e.g., a cellular telephone) functions, mobile web browsing, video game device, email service, navigation (e.g., global positioning system) services, media (e.g., music, video, and/or the like) player, audio recorder, video recorder, data storage device, calculator, scheduling/calendar services, other computing functions, or some combination thereof. In this regard, a multi-function mobile computing device 102 may be embodied as, for example, a mobile phone, smart phone, mobile computer, personal digital assistant, mobile communication device, game device, digital camera/camcorder, audio/video player, television device, radio receiver, digital video recorder, positioning device, any combination thereof, and/or the like.

In an exemplary embodiment, the multi-function mobile computing device 102 includes various means, such as a processor 104, memory 106, user interface 108, camera unit 114, camera driver unit 116, camera middleware unit 118, and camera application unit 120 for performing the various functions herein described. These means of the multi-function mobile computing device 102 as described herein may be embodied as, for example, hardware elements (e.g., a suitably programmed processor, combinational logic circuit, and/or the like), a computer program product comprising computer-readable program instructions (e.g., software or firmware) stored on a computer-readable medium (e.g. memory 106) that is executable by a suitably configured processing device (e.g., the processor 104), or some combination thereof.

The processor 104 may, for example, be embodied as various means including one or more microprocessors with accompanying digital signal processor(s), one or more processor(s) without an accompanying digital signal processor, one or more coprocessors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 1 as a single processor, in some embodiments the processor 104 comprises a plurality of processors. The plurality of processors may be in operative communication with each other and may be collectively configured to perform one or more functionalities of the multi-function mobile computing device 102 as described herein. In an exemplary embodiment, the processor 104 is configured to execute instructions stored in the memory 106 or otherwise accessible to the processor 104.

The memory 106 may include, for example, volatile and/or non-volatile memory. Although illustrated in FIG. 1 as a single memory, the memory 106 may comprise a plurality of memories, which may include volatile memory, non-volatile memory, or some combination thereof. In this regard, the memory 106 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. The memory 106 may be configured to store information, data, applications, instructions, or the like for enabling the multi-function mobile computing device 102 to carry out various functions in accordance with exemplary embodiments of the present invention. For example, in at least some embodiments, the memory 106 is configured to buffer input data for processing by the processor 104. Additionally or alternatively, in at least some embodiments, the memory 106 is configured to store program instructions for execution by the processor 104, which when executed by the processor 104 may cause the multi-function mobile computing device 102 to carry out one or more of the functionalities described herein. The memory 106 may store information in the form of static and/or dynamic information. This stored information may comprise, for example, recorded video data and/or captured image data. The information may be stored and/or used by the camera driver unit 116, camera middleware unit 118, and/or camera application unit 120 during the course of performing their functionalities.

The user interface 108 may be in communication with the processor 104 to receive an indication of a user input and/or to provide an audible, visual, mechanical, or other output to the user. As such, the user interface 104 may include, for example, a keyboard, a mouse, a joystick, a display (e.g., the display 112), a touch screen display (e.g., the display 112), a microphone, a speaker, and/or other input/output mechanisms. The user interface 104 may be in communication with the memory 106, camera unit 114, camera driver unit 116, camera middleware unit 118, and/or camera application unit 120, such as via a bus.

In some embodiments, the user interface 108 comprises a hardware trigger 110. The hardware trigger 10 may be configured to receive an indication of a user input commanding initiation of a video recording session and/or capture of a still image with the camera unit 114. The indication of a user input may comprise, for example, actuation of the hardware trigger 110. In this regard, actuation may comprise, for example, depression, sliding, and/or other actuation of the hardware trigger 110. The hardware trigger 110 may comprise, for example, a finger-depressible button interfaced with sensors configured to detect depression of the button. In some embodiments, the hardware trigger 110 comprises an analog trigger configured to detect and/or facilitate detection, such as by the camera application unit 120, of different levels or types of actuation of the hardware trigger 110.

In some embodiments, hardware trigger 110 comprises a pressure-sensitive hardware trigger that may trigger a first action when actuation of the hardware trigger is with a pressure greater than a predefined threshold and may trigger a second action when actuation of the hardware trigger is with a pressure less than a predefined threshold. For example, when embodied at least partly as a finger-depressible button, a full press of the button (e.g., actuation of the hardware trigger with a pressure greater than a predefined threshold) may trigger initiation of and/or conclusion of a video recording session and a partial press of the button (e.g., an actuation of the hardware trigger with a pressure less than a predefined threshold) may trigger capture of a still image. In some embodiments, the hardware trigger comprises a time-sensitive hardware trigger configured to facilitate determination of a period of time for which the hardware trigger 110 is actuated. For example, actuation of the hardware trigger 110 for a period of time greater than a predefined threshold may trigger initiation and/or conclusion of a video recording session, while actuation of the hardware trigger 110 for a period of time less than a predefined threshold may trigger capture of a still image. However, it will be appreciated that these relationships to a predefined threshold are merely for example. Accordingly, for example, an actuation of the hardware trigger 110 with a pressure less than a predefined threshold may trigger initiation of a video recording session and an actuation of the hardware trigger 110 with a pressure greater than the predefined threshold may trigger capture of a still image. Detection of a level or type of actuation may be through any appropriate means, such as, for example, varying electrical conductance at a sensor and/or other circuitry associated with the hardware trigger 110 that is caused by actuation of the hardware trigger 110.

The user interface 108 may further comprise a display 112. The display 112 may be configured to display images captured by the camera unit 114 and/or to display icons, soft keys, and/or the like for facilitating user interaction with the multi-function mobile computing device. In some embodiments, the display 112 comprises a touch screen display that may enable a user, for example, to select options or otherwise enter commands by touching selected area(s) of the display 112.

The camera unit 114 may comprise any means for capturing an image, video and/or audio for storage (e.g., in memory 106) and/or display (e.g., on the display 112). For example, the camera unit 114 may be configured to capture or sense an image within the view of the camera unit 114 and form a digital image from the sensed image. In addition, the camera unit 114 may be capable of capturing a series of image frames comprising a video clip, such as during a video recording session. As such, the camera unit 114 may include all hardware, such as a camera sensor, lens and/or optical component(s) for capturing images and/or videos. Alternatively, the camera module 36 may include only the hardware needed to view an image, while some other entity, such as the camera driver unit 116 creates a digital image file from a captured image. Additionally or alternatively, an object or objects within a field of view of the camera unit 114 may be displayed on the display to illustrate a view of an image currently displayed, which may be captured if desired by the user, such as by actuation of the hardware trigger 110.

The camera driver unit 116 may be embodied as various means, such as hardware, a computer program product comprising computer readable program instructions stored on a computer readable medium (e.g., the memory 106) and executed by a processing device (e.g., the processor 104), or some combination thereof and, in one embodiment, is embodied as or otherwise controlled by the processor 104. In embodiments where the camera driver unit 116 is embodied separately from the processor 104, the camera driver unit 116 may be in communication with the processor 104. The camera driver unit 116 may further be in communication with the memory 106, user interface 108, camera unit 114, camera middleware unit 118, and/or camera application unit 120, such as via a bus. The camera driver unit 116 may be configured to interface with the camera unit 114 to configure settings for the capture of a still image and/or video by the camera unit 114. In some embodiments, the camera driver unit 116 is configured to encode, decode, and/or otherwise process a still image and/or a video captured by the camera unit 114. In this regard, the camera driver unit 116 may be configured to compress and/or decompress image and/or video data according to, for example, a joint photographic experts group (JPEG) standard, a moving picture experts group (MPEG) standard, and/or other format. For example, the camera driver unit 116 may be configured to encode a raw bayer image captured by the camera unit 114 to a JPEG image. In some embodiments, the camera driver unit 116 comprises a hardware accelerator, co-processor, or other hardware that may be configured to encode/decode image and/or video data or to at least assist the processor 104 with encoding/decoding of image and/or video data. Such a hardware accelerator may comprise memory that may buffer or at least temporarily store image and/or video data during processing of the data.

The camera middleware unit 118 may be embodied as various means, such as hardware, a computer program product comprising computer readable program instructions stored on a computer readable medium (e.g., the memory 106) and executed by a processing device (e.g., the processor 104), or some combination thereof and, in one embodiment, is embodied as or otherwise controlled by the processor 104. In embodiments where the camera middleware unit 118 is embodied separately from the processor 104, the camera middleware unit 118 may be in communication with the processor 104. The camera middleware unit 118 may further be in communication with the memory 106, user interface 108, camera unit 114, camera driver unit 116, and/or camera application unit 120, such as via a bus. The camera middleware unit 118 is configured in some embodiments to serve as an interface between the camera driver unit 116 and the camera application unit 120, which serves as a user-level interface for controlling at least some functions of the camera unit 114. In this regard, the camera middleware unit 118 may be configured to, for example, gather still images, video, and/or other data from the camera driver unit 116 and return the data to the camera application unit 120 so that the data may be viewed and/or manipulated by the user. Further, the camera middleware unit 118 may be configured to receive commands, settings, or other information related to control of the camera unit 114 from the camera application unit 120 and pass the information to the camera driver unit 116, which may use the information to control the camera unit 114.

The camera application unit 120 may be embodied as various means, such as hardware, a computer program product comprising computer readable program instructions stored on a computer readable medium (e.g., the memory 106) and executed by a processing device (e.g., the processor 104), or some combination thereof and, in one embodiment, is embodied as or otherwise controlled by the processor 104. In embodiments where the camera application unit 120 is embodied separately from the processor 104, the camera application unit 120 may be in communication with the processor 104. The camera application unit 120 may further be in communication with the memory 106, user interface 108, camera unit 114, camera driver unit 116, and/or camera middleware unit 118, such as via a bus. The camera application unit 120 is configured in some embodiments to control a user interface through which the user may control the camera unit 114 as well as to provide for the display of image and/or video data captured by the camera unit 114 and/or in the viewing frame of the camera unit 114 on the display 112. In this regard, the camera application unit 120 may be configured to interface with the camera middleware unit 118 to exchange data with the camera middleware unit 118. The camera application unit 120 may further be configured to control aspects of the user interface 108 to facilitate user interaction with and/or control of the camera unit 114 and may receive indications of user actuation of the hardware trigger 110.

In order to facilitate concurrent video recording and still image capture, embodiments of the invention provide for the integration and cooperation of the user interface 108 (e.g., the hardware trigger 110 and display 112), camera unit 114, camera driver unit 116, camera middleware unit 118, and camera application unit 120. For example, upon user actuation of the hardware trigger 110, the electrical signals generated by actuation of the hardware trigger 110 may comprise a command signal generated responsive to the actuation of the hardware trigger 110, which may be conveyed to the camera application unit 120. The camera application unit 120 may then interpret the received command signal, such as to determine whether the received command signal comprises a command to initiate/terminate a video recording session or a command to capture a still image. The camera application unit 120 may then generate an appropriate command (e.g., to initiate/terminate a video recording session or to capture a still image) to send to the camera middleware unit 118. The camera middleware unit 118 may then forward the command to the camera driver unit 116, which may interface with the camera unit 114 and take appropriate action based at least in part upon the command.

The camera driver unit 116 may be configured to receive a setting from the camera middleware unit 118 specifying a size (e.g., a resolution) for a still image captured concurrent with a video recording session. This setting may be specified by a user over the user interface 108 and received by the camera application unit 120, which may then relay the setting to the camera middleware unit 118. For a given specified image size, the camera middleware unit 118 may be configured to determine how many captured still images may be captured during a video recording session. In this regard, a memory buffer of limited size may be used to at least temporarily store captured image data for processing during video recording. The camera middleware unit 118 may be further configured to provide the determined number of captured images to the camera application unit 120, which may then indicate the number to the user, such as by causing the user interface 108 to display an indication of the number on the display 112. Then, for example, when a still image is captured, the number indicated on the display 112 may be decremented until reaching 0, at which point, still image capture may be disabled for the duration of the ongoing video recording session. If the number of maximum possible image captures is reached, one or more of the camera driver unit 116, camera middleware unit 118, or camera application unit 120 may be configured to respond with an error message to a still image capture command.

Further still image capture parameters and/or settings may be determined automatically by the camera driver unit 116. Such parameters and/or settings may comprise, for example, exposure time, exposure gain, zoom factor, color effects, focus settings, and/or the like. These parameters and/or settings may be determined by the camera driver unit 116 based at least in part upon resource (e.g., hardware and/or software) capabilities and availability during an ongoing video recording session so as not to disrupt the video recording session. The camera driver unit 116 may be further configured to determine a one or more still image capture settings based at least in part upon one or more settings used for an ongoing video recording session while taking into consideration. When commanded to capture a still image through a user actuation of the hardware trigger 110, the camera driver unit 116 may then initiate a capture of a still image by the camera unit 114 using the determined set of still image capture settings. In this regard, selection of at least some image capture parameters and/or settings may be decoupled from the camera middleware unit 118 and/or camera application unit 120 such that a user may not select or otherwise override certain settings for still image capture during an ongoing video recording session.

The camera driver unit 116 may be configured to generate a smaller resolution thumbnail image of a captured still image. When capturing a still image concurrent with video recording, the camera driver unit 116 may be configured to determine how to generate a thumbnail image without disrupting the video recording session. In situations wherein a downscaled version of the captured still image is not included as a video frame of the video captured by the video recording session and sufficient resources are not available to process a thumbnail image of the captured still image without disrupting the video recording session, the camera driver unit 116 may be configured to not generate a thumbnail image. Consequently, there may not be a preview image to display to the user on the display 112 following capture of the still image. The camera driver unit 116 may be configured to generate a thumbnail image having the same size as a default setting for thumbnail size generally used in situations wherein a downscaled version of the captured still image is not included as a video frame of the video captured by the video recording session and sufficient resources are available to process a thumbnail image of the captured still image without disrupting the video recording session. Consequently, the thumbnail image may be presented to the user on the display 112 by the camera application unit 120 following capture of the still image. The camera driver unit 116 may be configured to generate a thumbnail the size of a video frame in the video recording situations in situations wherein the downscaled captured still image is encoded into the video stream. In this regard, the camera driver unit 116 may be configured to utilize a frame from the video recording as the thumbnail and the thumbnail image may be displayed on the display 112 by the camera application unit 120.

In order to avoid a gap in the video stream (e.g., one or more dropped frames) captured during a video recording session, such as due to a change in mode of the camera unit 114 to capture a still image concurrent with the video recording session, the camera driver unit 116 may be configured to capture a still image without changing the sensor configuration settings from those used for image recording. The camera driver unit 116 may be further configured to use no or little binning for the video recording session to enable greater resolution for still images captured during the video recording session.

In order to mitigate negative effects of processing a captured still image concurrent with video encoding during a video recording session, the camera driver unit 116 may be configured to delay still image processing (e.g., compression and/or encoding) until after conclusion of the video recording session. Accordingly, the camera driver unit 116 may be configured to save a raw bayer captured by the camera unit 114 to a memory, such as the memory 106, and then process the raw bayer after conclusion of the video recording session. If the camera driver unit 116 comprises a hardware accelerator having sufficient resources to process a captured raw bayer concurrent with the video recording session without disrupting the video recording session, the camera driver unit 116 may, however use the hardware accelerator to process the raw bayer capture during the video recording session.

In some situations, the multi-function mobile computing device 102 may be memory limited in that there may be a finite amount of memory (e.g., in memory 106 or some other memory used by the camera driver unit 116) available for saving still images captured concurrent with a video recording session. Accordingly, the camera driver unit 116 may be configured to store a raw bayer image captured by the camera unit 114 to memory integrated into a hardware accelerator of the camera driver unit 116, a mass storage random access memory accessible to the camera driver unit 116, or even to a non-volatile memory. The camera driver unit 116 may additionally or alternatively be configured to apply a simple compression algorithm to captured raw bayer images so that a stored raw bayer does not consume as much memory as an uncompressed bayer image when stored in a memory prior to processing of the stored bayer image. The simple compression algorithm may comprise a lossless compression algorithm.

In some embodiments, the camera driver unit 116 is configured to generate ancillary data for a captured still image. The camera driver unit 116 may store the ancillary data in association with the captured still image and/or may store the ancillary data in a different buffer from one used to buffer captured image data. This ancillary data may comprise, for example, metadata. The ancillary data may serve to communicate capture data related to a captured still image to the camera middleware unit 118. The camera middleware unit 118 may be configured to use the ancillary data to generate an exchangeable image file format (EXIF) header to write to a file for a captured still image. In this regard, the camera middleware unit 118 may write an EXIF header to a captured still image stored as a JPEG file. The capture data described by ancillary data may comprise a plurality of descriptor data types, including, for example, exposure settings, sensor characteristics, f-number, focal length, aperture value, information about the multi-function mobile computing device 102 (e.g., model name/information), geolocation coordinates indicating a location where the image was captured, a time stamp indicating a time at which the image was captured, and/or the like. Descriptor data may be stored in type-specific fields within the ancillary data. In one embodiment, the ancillary data may be structured as follows:

| Size | Field | Explanation |
|---|---|---|
| TUint32 | ExposureTime; | Exposure time in micro seconds |
| TUint16 | AnalogGain; | Analog gain, Client needs to divide it by AnalogGainDiv |
| TUint16 | DigitalGain; | Digital gain, Client needs to divide it by DigitalGainDiv |
| TUint16 | IsoSpeed; | ISO Speed value |
| TUint8 | AnalogGainDiv; | Analog gain divider |
| TUint8 | DigitalGainDiv; | Digital gain divider |
| TUint8 | IsoRef; | ISO reference value |
| TUint8 | Version; | Ancillary data structure version number. 3 for this structure |
| TUint16 | PARWidth; | Width value in pixel aspect ratio e.g. 4 if PAR is 4:3 |
| TUint16 | PARHeight; | Height value in pixel aspect ratio e.g. 3 if PAR is 4:3 |
| TUint16 | ErrorIndications; | Errors occurred in frame |
| TUint8 | InternalByte; | For driver's internal use |
| TUint8 | Padding1; | For future use |
| TUint16 | FNumber; | FNumber, needs to be divided with FNumberDiv |
| TUint16 | FocalLength; | Focal length, needs to be divided with FocalLengthDiv |
| TUint16 | ApertureValue; | Aperture value, needs to be divided with ApertureValueDiv |
| TUint8 | FNumberDiv; | FNumber divider |
| TUint8 | FocalLengthDiv; | Focal length divider |
| TUint8 | ApertureValueDiv; | Aperture value divider |
| TUint8 | Padding2; | For future use |
| TUint16 | MakerNoteOffset; | Maker note offset from start of Ancillary Data |
| TUint16 | MakerNoteLength; | Maker note length in bytes |
| TUint8 | Padding3; | |
| TUint8 | HistogramBitsPerBin; | Number of bits per bin in histogram data |
| TUint16 | HistogramOffset; | Histogram data offset from start of Ancillary Data |
| TUint16 | HistogramLength; | Histogram data length in bytes |

It will be appreciated, however that the above example format for ancillary data is merely for purposes of example. Accordingly, ancillary data generated by the camera driver unit 116 may include additional fields or fewer fields. Further, the size of one or more fields of the ancillary data may differ from the example sizes listed above. In some embodiments, maker note and/or histogram data may be included in the ancillary data and may follow the structure described above. If, however one or more of a maker note or historgram data is not included, a corresponding field size may be set to 0.

Embodiments of the invention further provide user interfaces for facilitating concurrent video recording and still image capture. In a first user interface, a user may use an element (e.g., a button, switch, touch screen display, or other selector means) of the user interface 108 to interact with the camera application unit 120 to select a video capture mode feature of the multi-function mobile computing device 102, if not already selected. The user may further actuate a trigger, such as, for example, the hardware trigger 110 to initiate a video recording session. This actuation may comprise, for example, actuation of the hardware trigger 110 with a pressure greater than a predefined threshold (e.g., a full press of the hardware trigger 110). In response to initiation of the video recording session, the camera application unit 120 may cause an indication that a video capture session is ongoing to be displayed on the display 112. The camera application unit 120 may additionally or alternatively cause an indication that still image capture is enabled to be displayed on the display 112 to alert the user of the possibility of capturing still images concurrent with the video capture session. In order to capture a still image, the user may actuate the trigger with a pressure less than the predefined threshold (e.g., a half press of the hardware trigger 110). The camera driver unit 116 may then initiate capture of the still image and capture the still image if sufficient resources are available. The camera driver unit 116 may process and/or store a raw bayer captured as described above and the camera application unit 120 may cause a thumbnail (if generated by the camera driver unit 116) of the captured image to be displayed on the display 112. The user may similarly capture additional still images during the video recording session provided sufficient resources are available. If at any point the camera driver unit 116 determines sufficient resources are not available to capture a still image, the camera driver unit 116 may disable still image capture for the duration of the video recording session or until resources are again available to enable still image capture. The camera application unit 120 may display an indication on the display 112 indicating that still image capture is not available when still image capture is disabled. If the user attempts to trigger capture of a still image when still image capture is not available, an error message may be returned by the camera driver unit 116 and displayed on the display 112 by the camera application unit 120. The user may conclude the video recording session by actuating the hardware trigger 110 with a pressure greater than the predefined threshold.

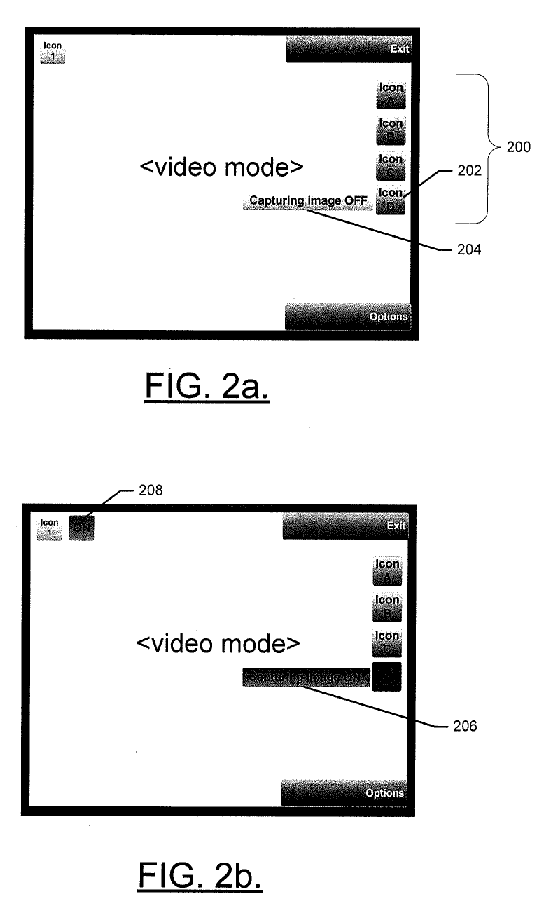

In a second user interface, a user may use an element (e.g., a button, switch, touch screen display, or other selector means) of the user interface 108 to interact with the camera application unit 120 to select a video capture mode feature of the multi-function mobile computing device 102, if not already selected. Referring to the screen capture of FIG. 2a, the user may use a toolbar 200 comprising a plurality of icons (e.g., the icon 202) displayed on the display 112 to activate still image capture concurrent with a video recording session. For example, the user may select the icon 202 (e.g., by touching the icon 202 if the display 112 is a touch screen display and/or by actuating a button or other soft key hardware input associated with the displayed icon 202), which initially may illustrate that image capture is “OFF” 204. The user may then make a selection (e.g., through the user interface 108, such as by actuating a hardware button associated with the displayed icon 202) to activate image capture and as illustrated in the screen capture of FIG. 2b, the icon 202 may then indicate that image capture is “ON” 206. The camera application unit 120 may then cause an icon 208 to be displayed during the video recording session to indicate that still image capture is activated. The user may then actuate the hardware trigger 110 to initiate a video recording session. This actuation may comprise, for example, actuation of the hardware trigger 110 with a pressure greater than a predefined threshold (e.g., a full press of the hardware trigger 110). In response to initiation of the video recording session, the camera application unit 120 may cause an indication that a video capture session is ongoing to be displayed on the display 112. In order to capture a still image, the user may actuate the hardware trigger 110 with a pressure less than the predefined threshold (e.g., a half press of the hardware trigger 110). The camera driver unit 116 may then initiate capture of the still image and capture the still image if sufficient resources are available. The camera driver unit 116 may process and/or store a raw bayer captured as described above and the camera application unit 120 may cause a thumbnail (if generated by the camera driver unit 116) of the captured image to be displayed on the display 112. The user may similarly capture additional still images during the video recording session provided sufficient resources are available. If at any point the camera driver unit 116 determines sufficient resources are not available to capture a still image, the camera driver unit 116 may disable still image capture for the duration of the video recording session or until resources are again available to enable still image capture. The camera application unit 120 may display an indication on the display 112 indicating that still image capture is not available, or may at least stop displaying the icon 208 when still image capture is disabled. If the user attempts to trigger capture of a still image when still image capture is not available, an error message may be returned by the camera driver unit 116 and displayed on the display 112 by the camera application unit 120. The user may conclude the video recording session by actuating the hardware trigger 110 with a pressure greater than the predefined threshold.

In a third user interface, a user may use an element (e.g., a button, switch, touch screen display, or other selector means) of the user interface 108 to interact with the camera application unit 120 to select a video capture mode feature of the multi-function mobile computing device 102, if not already selected. The user may further use the user interface 108 to activate image capture during a video recording session, such as by using the user interface 108 to select a settings option embedded in an options menu. The user may further actuate the hardware trigger 110 to initiate a video recording session. In response to initiation of the video recording session, the camera application unit 120 may cause an indication that a video capture session is ongoing to be displayed on the display 112. The camera application unit 120 may additionally or alternatively cause an indication that still image capture is enabled to be displayed on the display 112. In order to capture a still image, the user may press a soft key configured for initiating capture of a still image during the video recording session. The camera driver unit 116 may then initiate capture of the still image and capture the still image if sufficient resources are available. The camera driver unit 116 may process and/or store a raw bayer captured as described above and the camera application unit 120 may cause a thumbnail (if generated by the camera driver unit 116) of the captured image to be displayed on the display 112. The user may similarly capture additional still images during the video recording session provided sufficient resources are available. If at any point the camera driver unit 116 determines sufficient resources are not available to capture further still images, the camera driver unit 116 may disable still image capture for the duration of the video recording session or until resources are again available to enable still image capture. The camera application unit 120 may display an indication on the display 112 indicating that still image capture is not available when still image capture is disabled. If the user attempts to trigger capture of a still image when still image capture is not available, an error message may be returned by the camera driver unit 116 and displayed on the display 112 by the camera application unit 120. The user may conclude the video recording session by again actuating the hardware trigger 110.

In a fourth user interface, a user may use an element (e.g., a button, switch, touch screen display, or other selector means) of the user interface 108 to interact with the camera application unit 120 to select a video capture mode feature of the multi-function mobile computing device 102, if not already selected. The user may further use the user interface 108 to activate image capture during a video recording session, such as by using the user interface 108 to select a settings option embedded in an options menu. The user may then actuate the hardware trigger 110 to initiate a video recording session. In response to initiation of the video recording session, the camera application unit 120 may cause an indication that a video capture session is ongoing to be displayed on the display 112. The camera application unit 120 may additionally or alternatively cause an indication that still image capture is enabled to be displayed on the display 112. In order to capture a still image, the user may actuate the hardware trigger 110 with a pressure less than the predefined threshold (e.g., a half press of the hardware trigger 110) and/or press a soft key, such as may be indicated on the display 112. The camera driver unit 116 may then initiate capture of the still image and capture the still image if sufficient resources are available. The camera driver unit 116 may process and/or store a raw bayer captured as described above and the camera application unit 120 may cause a thumbnail (if generated by the camera driver unit 116) of the captured image to be displayed on the display 112. The user may similarly capture additional still images during the video recording session provided sufficient resources are available. If at any point the camera driver unit 116 determines sufficient resources are not available to capture further still images, the camera driver unit 116 may disable still image capture for the duration of the video recording session or until resources are again available to enable still image capture. The camera application unit 120 may display an indication on the display 112 indicating that still image capture is not available when still image capture is disabled. If the user attempts to trigger capture of a still image when still image capture is not available, an error message may be returned by the camera driver unit 116 and displayed on the display 112 by the camera application unit 120. The user may conclude the video recording session by actuating the hardware trigger 110 with a pressure greater than the predefined threshold (e.g., a full press of the hardware trigger 110).

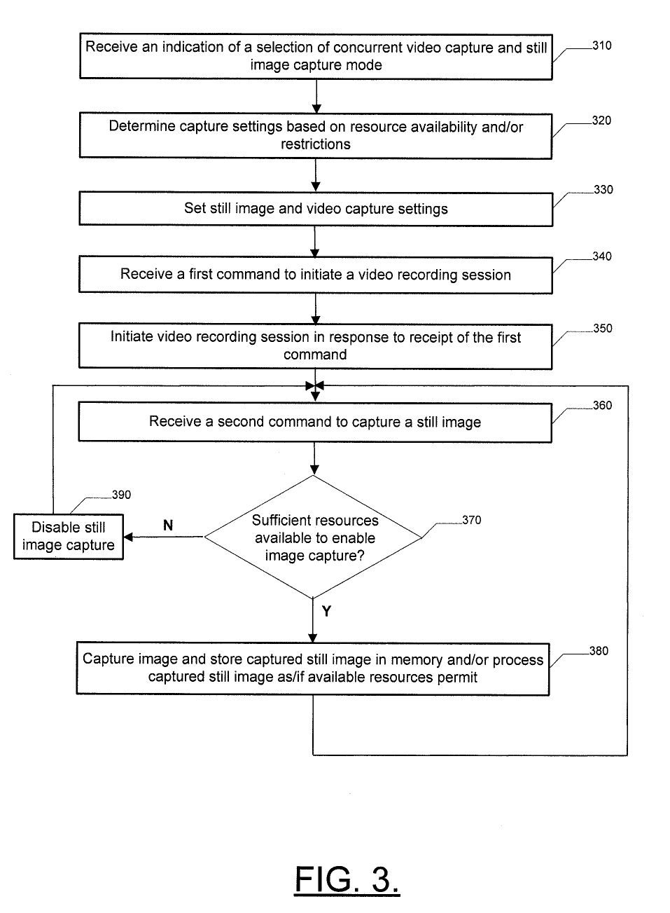

FIG. 3 is a flowchart of a system, method, and computer program product according to exemplary embodiments of the invention. It will be understood that each block or step of the flowchart, and combinations of blocks in the flowchart, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by one or more memory devices of a mobile terminal, server, or other computing device and executed by a processor in the computing device. In some embodiments, the computer program instructions comprising the computer program product(s) which embody the procedures described above may be stored by memory devices of a plurality of computing devices. As will be appreciated, any such computer program product may be loaded onto a computer or other programmable apparatus to produce a machine, such that the instructions of the computer program product which execute on the computer or other programmable apparatus create means for implementing the functions specified in the flowchart block(s) or step(s). Further, the computer program product may comprise one or more computer-readable memories on which the computer program instructions may be stored such that the one or more computer-readable memories can direct a computer or other programmable apparatus to function in a particular manner, such that the computer program product comprises an article of manufacture including instruction means which implement the function specified in the flowchart block(s) or step(s). The computer program instructions of one or more computer program products may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart block(s) or step(s).

FIG. 3 illustrates a flowchart according to an exemplary method for facilitating concurrent video recording and still image capture according to an exemplary embodiment of the present invention. Operation 310 may comprise the camera application unit 120 receiving an indication of a user selecting a video capture mode feature supporting concurrent video capture and still image capture using an element of the user interface 108. Operation 310 may further comprise the camera application unit 120 sending an indication of selection of the video capture mode to the camera middleware unit 118, which may set the newly selected mode in the camera middleware unit 118 and forward the indication of selection to the camera driver unit 116. Operation 320 may then comprise the camera driver unit 116 determining video capture and/or still image capture settings based at least in part upon resource (e.g., memory, processor, and/or the like) availability and/or restrictions. It will be appreciated, however, that the camera driver unit 116 may perform at least some of operation 320 and/or repeat portions of operation 320 following receipt of a command to capture a still image during a video recording session, such as, for example, following operation 360. Operation 330 may then comprise setting still image and video capture settings based at least in part upon the determinations of operation 320. The camera application unit 120 may then receive a first command to initiate a video recording session, at operation 340. The command may be responsive to a user actuation of the hardware trigger 110, such as by actuating the hardware trigger 110 with a pressure greater than a predefined threshold. Operation 340 may further comprise the camera application unit 120 sending instructions to the camera middleware unit 118 to initiate a video recording session. Operation 340 may additionally comprise the camera middleware unit 118 forwarding instructions to the camera driver unit 116 to initiate a video recording session. The camera driver unit 116 may then initiate a video recording session in response to receipt of the first command, at operation 350.

Once the video recording session has been initiated, the user may terminate the video recording session at any time, such as by actuating the hardware trigger 110 with a pressure greater than the predefined threshold, in response to which the camera driver unit 116 may terminate the video recording session. During the video recording session, the camera application unit 120 may receive a second command to capture a still image. The second command may be responsive to a user actuation of the hardware trigger 110 with a pressure less than the predefined threshold. Operation 360 may further comprise the camera application unit 120 sending instructions to the camera middleware unit 118 to capture a still image. Operation 360 may additionally comprise the camera middleware unit 118 forwarding instructions to the camera driver unit 116 to capture a still image.

The camera driver unit 116 may then determine whether sufficient resources are available to capture a still image concurrent with the video recording session without disrupting the video recording session, at operation 370. If the camera driver unit 116 determines sufficient resources are available, the camera driver unit 116 may command the camera unit 114 to capture a still image, at operation 380. Operation 380 may additionally comprise the camera driver unit 116 storing the captured still image in memory and/or processing the captured still image as permitted by available resources. The method may then return to await receipt of another command to capture a still image (e.g., operation 360) and/or to await receipt of a command to terminate the video recording session. Following termination of the video recording session, the camera driver unit 116 may complete any processing of still images captured during the video recording session that was not performed during the video recording session so as not to disrupt the video recording session.

If, however, the camera driver unit 116 determines at operation 370 that sufficient resources are not available, the camera driver unit 116 may disable still image capture, at operation 390. Operation 390 may further comprise the camera driver unit 116 generating an error message and sending the error message to the camera middleware unit 118, which may then forward the error message to the camera application unit 120. The camera application unit 120 may then alert the user, such as through an indication on the display 112 that still image capture failed and/or that still image capture is disabled. Following operation 390, the method may return to await receipt of another command to capture a still image (e.g., operation 360) and/or to await receipt of a command to terminate the video recording session.

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, may be implemented by special purpose hardware-based computer systems which perform the specified functions or steps, or combinations of special purpose hardware and computer program product(s).

The above described functions may be carried out in many ways. For example, any suitable means for carrying out each of the functions described above may be employed to carry out embodiments of the invention. In one embodiment, a suitably configured processor may provide all or a portion of the elements of the invention. In another embodiment, all or a portion of the elements of the invention may be configured by and operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

As such, then, some embodiments of the invention provide several advantages to computing devices and computing device users. Embodiments of the invention provide for methods, apparatuses, and computer program products to facilitate concurrent video recording and still image capture in multi-function mobile computing devices. In this regard, embodiments of the invention provide for concurrent video recording and still image capture using a single hardware trigger on a multi-function mobile computing device. Embodiments of the invention further provide for automatic determination by a camera driver of configuration settings to use for still image capture so as not to disrupt an ongoing video recording session.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
receiving a first command to initiate a video recording session, wherein the first command is responsive to a first user actuation of a trigger;
initiating the video recording session in response to receipt of the first command;
receiving a second command to capture a still image, wherein the second command is responsive to a second user actuation of the trigger; and
initiating capture of the still image concurrent with the video recording session in response to receipt of the second command.

2. The method according to claim 1, wherein the trigger comprises a pressure-sensitive trigger, and wherein:
the first actuation of the trigger comprises an actuation of the trigger with a pressure that is one of greater or less than a predefined threshold; and
the second actuation of the trigger comprises an actuation of the trigger with a pressure that is another one of greater or less than the predefined threshold and that has a different relationship to the predefined threshold than the pressure associated with the first actuation.

3. The method according to claim 1, wherein the trigger comprises a time-sensitive trigger configured to facilitate determination of a period of time for which the trigger is actuated; and wherein:
the first actuation of the trigger comprises an actuation of the trigger for a period of time that is one of greater or less than a predefined threshold; and
the second actuation of the trigger comprises an actuation of the trigger for a period of time that is another one of greater or less than the predefined threshold and that has a different relationship to the predefined threshold than the time associated with the first actuation.

4. The method according to claim 1, wherein initiating capture of the still image concurrent with the video recording session comprises:
determining whether sufficient resources are available to capture the still image concurrent with the video recording session;
capturing the still image only when there are sufficient resources available to capture the still image concurrent with the video recording session; and
otherwise, when sufficient resources are not available to capture the still image concurrent with the video recording session, disabling still image capture for duration of the video recording session.

5. The method according to claim 1, wherein initiating capture of the still image concurrent with the video recording session comprises:
determining one or more still image capture settings based at least in part upon one or more settings used for the video recording session so as not to disrupt the video recording session; and
capturing the still image concurrent with the video recording session based at least in part upon the determined one or more still image capture settings.

6. The method according to claim 1, wherein initiating capture of the still image concurrent with the video recording session comprises capturing a raw bayer of the still image; and further comprising:
saving the raw bayer of the captured still image to a memory; and
processing the raw bayer after conclusion of the video recording session.

7. The method according to claim 6, further comprising:
applying a compression algorithm to the raw bayer prior to saving the raw bayer.

8. A computer program product comprising at least one computer-readable storage medium having computer-readable program instructions stored therein, the computer-readable program instructions comprising:
a program instruction for receiving a first command to initiate a video recording session to be received, wherein the first command is responsive to a first user actuation of a trigger;
a program instruction for providing for initiation of the video recording session in response to receipt of the first command;
a program instruction for receiving a second command to capture a still image to be received, wherein the second command is responsive to a second user actuation of the trigger; and
a program instruction for providing for initiation of capture of the still image concurrent with the video recording session in response to receipt of the second command.

9. The computer program product according to claim 8, wherein the trigger comprises a pressure-sensitive trigger, and wherein:
the first actuation of the trigger comprises an actuation of the trigger with a pressure that is one of greater or less than a predefined threshold; and
the second actuation of the trigger comprises an actuation of the trigger with a pressure that is another one of greater or less than the predefined threshold and that has a different relationship to the predefined threshold than the pressure associated with the first actuation.

10. The computer program product according to claim 8, wherein the program instruction for providing for initiation of capture of the still image concurrent with the video recording session comprises:
instructions for determining whether sufficient resources are available to capture the still image concurrent with the video recording session;
instructions for providing for capture of the still image only when there are sufficient resources available to capture the still image concurrent with the video recording session; and
instructions for otherwise, when sufficient resources are not available to capture the still image concurrent with the video recording session, providing for disabling still image capture for duration of the video recording session.

11. The computer program product according to claim 8, wherein the program instruction for providing for initiation of capture of the still image concurrent with the video recording session comprises:
instructions for determining one or more still image capture settings based at least in part upon one or more settings used for the video recording session so as not to disrupt the video recording session; and
instructions for providing for capture of the still image concurrent with the video recording session based at least in part upon the determined one or more still image capture settings.

12. The computer program product according to claim 8, wherein the program instruction for providing for initiation of capture of the still image concurrent with the video recording session comprises instructions for providing for capture of a raw bayer of the still image; and further comprising:
a program instruction for saving the raw bayer of the captured still image to a memory; and
a program instruction for processing the raw bayer after conclusion of the video recording session.

13. The computer program product according to claim 12, further comprising:
a program instruction for applying a compression algorithm to the raw bayer prior to saving the raw bayer.

14. An apparatus comprising a processor and a memory storing instructions that when executed by the processor cause the apparatus to at least:
receive a first command to initiate a video recording session, wherein the first command is responsive to a first user actuation of a trigger of the apparatus;
initiate the video recording session in response to receipt of the first command;
receive a second command to capture a still image, wherein the second command is responsive to a second user actuation of the trigger; and
initiate capture of the still image concurrent with the video recording session in response to receipt of the second command.

15. The apparatus according to claim 14, wherein the trigger comprises a pressure-sensitive trigger, and wherein:
the first actuation of the trigger comprises an actuation of the trigger with a pressure that is one of greater or less than a predefined threshold; and
the second actuation of the trigger comprises an actuation of the trigger with a pressure that is another one of greater or less than the predefined threshold and that has a different relationship to the predefined threshold than the pressure associated with the first actuation.

16. The apparatus according to claim 14, wherein the trigger comprises a time-sensitive trigger configured to facilitate determination of a period of time for which the trigger is actuated; and wherein:
the first actuation of the trigger comprises an actuation of the trigger for a period of time that is one of greater or less than a predefined threshold; and
the second actuation of the trigger comprises an actuation of the trigger for a period of time that is another one of greater or less than the predefined threshold and that has a different relationship to the predefined threshold than the time associated with the first actuation.

17. The apparatus according to claim 14, wherein the instructions when executed cause the apparatus to initiate capture of the still image concurrent with the video recording session by:
determining whether sufficient resources are available to capture the still image concurrent with the video recording session;
capturing the still image only when there are sufficient resources available to capture the still image concurrent with the video recording session; and
otherwise, when sufficient resources are not available to capture the still image concurrent with the video recording session, disabling still image capture for duration of the video recording session.

18. The apparatus according to claim 14, wherein the instructions when executed cause the apparatus to initiate capture of the still image concurrent with the video recording session by:
determining one or more still image capture settings based at least in part upon one or more settings used for the video recording session so as not to disrupt the video recording session; and
capturing the still image concurrent with the video recording session based at least in part upon the determined one or more still image capture settings.

19. The apparatus according to claim 14, wherein the instructions when executed cause the apparatus to initiate capture of the still image concurrent with the video recording session by capturing a raw bayer of the still image; and wherein the instructions when executed further cause the apparatus to:
save the raw bayer of the captured still image to the memory; and
process the raw bayer after conclusion of the video recording session.

20. The apparatus according to claim 19, wherein the instructions when executed further cause the apparatus to apply a compression algorithm to the raw bayer prior to saving the raw bayer.
